(19) United States
(12) Patent Application Publication
(10) Pub. No.: US 2023/0096098 A1
(43) Pub. Date: Mar. 30, 2023

(54) MULTI-TOUCH USER INTERFACE FOR AN ELECTRONIC DEVICE

(71) Applicant: Tangiamo Touch Technology AB, Göteborg (SE)

(72) Inventors: Jimmy Eiterjord, Västra Frölunda (SE); Mats Nordahl, Trångsund (SE)

(73) Assignee: Tangiamo Touch Technology AB, Göteborg (SE)

(21) Appl. No.: 17/994,995

(22) Filed: Nov. 28, 2022

Related U.S. Application Data
(63) Continuation of application No. 15/540,423, filed on Jun. 28, 2017, now abandoned.

(30) Foreign Application Priority Data
Feb. 2, 2015 (EP) 15153523.4

(51) Int. Cl. G06F 3/041; G06F 3/044

(52) U.S. Cl. CPC G06F 3/041; G06F 3/04166; G06F 3/0446; G06F 2203/04104

(57) ABSTRACT

The present invention generally relates to an electronic device comprising a touch interface for a user to control functionality of the electronic device, and specifically to a user interface allowing more than one user to control such functionality. The invention also relates to a corresponding method and a computer program product.

### CROSS-REFERENCE TO RELATED APPLICATIONS

This application is a continuation of U.S. patent application Ser. No. 15/540,423, filed Jun. 28, 2017, which is a 371 U.S. National Stage of International Application No. PCT/SE2016/050077, filed Feb. 2, 2016, which claims priority to European Application No. 15153523.4, filed on Feb. 2, 2015. The disclosures of each of the above applications are incorporated herein by reference in their entirety.

### TECHNICAL FIELD

The present invention generally relates to an electronic device comprising a touch interface for a user to control functionality of the electronic device, and specifically to a user interface allowing more than one user to control such functionality. The invention also relates to a corresponding circuitry, control method and a computer program product.

### BACKGROUND OF THE INVENTION

Today, electronic devices provide an increasing amount of functionality with a decreasing size and weight. By continually integrating more and more functions within electronic devices, cost is reduced and reliability is therefore increased. Touch interfaces are frequently used in combination with e.g. electroluminescent displays comprised with such electronic devices for providing simplified functional control of the electronic device.

There are several types of touch interface technologies including resistive, capacitive, infrared, surface acoustic wave, electromagnetic, near field imaging, etc. Each of these technologies has advantages and disadvantages that are taken into account when designing or configuring the touch interface. In resistive technologies, a resistive touch interface panel is coated with a thin metallic electrically conductive and resistive layer that causes a change in the electrical current which is registered as a touch event and is sent to the controller for processing.

In capacitive technologies, the capacitive touch interface panel is coated with a material, typically indium tin oxide, which conducts a continuous electrical current across the sensor area, typically implemented using a crossed grid of electrodes comprising a set of drive lines and a set of sense lines. Capacitance is measured between the sets of drive and sense lines, an implementation generally referred to as a mutual capacitance implementation. Capacitive sensors can either be touched with a bare finger or with a conductive device being held by a bare hand.

In surface acoustic wave technologies, ultrasonic waves that pass over the touch interface panel. When the panel is touched, a portion of the wave is absorbed. This change in the ultrasonic waves registers the position of the touch event and sends this information to the controller for processing. Surface wave touch interface panels can be damaged by outside elements. Contaminants on the surface can also interfere with the functionality of the touch interface. In infrared technologies, the infrared touch screen panel employs one of two very different methodologies. One method uses thermal that induces changes of the surface resistance. This method was sometimes slow and required warm hands. Another method is an array of vertical and horizontal IR sensors that detects the interruption of a modulated light beam near the surface of the screen. IR touch screens have the most durable surfaces and are used in many military applications that require a touch panel display.

Some of the above discussed technologies, such as capacitive, are capable of reporting multiple points when multiple objects are touched on the sensing surface of the touch interface panel. Such functionality may allow for the implementation of different gesture based feature recognition, such as a simultaneous two-finger “pinching” gesture, a short pair of parallel strokes, or other specific sequences of two-finger strokes.

In some implementations it may also be possible to provide a multi-user interface environment allowing for the provision of rich collaborative workspaces, in which two or more users may work side-by-side at the same touch interface, typically arranged at a large scale display. To be able to differentiate between multiple users, e.g. including a first and a second user, different technology may be used, including for example by means of camera based triangulation such as disclosed in U.S. Pat. No. 7,599,520. A further improvement as to differentiation between multiple users is disclosed in U.S. Pat. No. 8,851,475, by the applicant, where an electronic identification means is used for transmitting a differentiating electrical signal through the body of each of the users to a thereto connected capacitive touch panel.

Even though the implementation proposed in U.S. Pat. No. 8,851,475 shows a promising approach to allowing multiple users to simultaneously access and collaborate at a large scale touch interface, there is still a desire to allow for further improvements, specifically for further exploring the possibilities arising in a multi-user multi-finger environment.

### SUMMARY OF THE INVENTION

According to an aspect of the invention, the above is at least partly alleviated by a multiple-user touch system for an electronic device, the touch system comprising a touch user interface, and touch control circuitry connected to the touch user interface, the control circuitry being configured to determine if a first object being positioned at a first coordinate at the touch user interface is related to a second object being positioned at a second coordinate at the touch user interface, wherein the first and the second coordinate are spatially separated at the touch user interface and the relation between the first and the second object is determined based on information relating to the first and the second coordinate for the first and the second object, respectively.

The general concept of the present invention is based on the fact that it may be possible to improve the usability of an electronic device comprising a touch interface, such as an electronic device comprised with a touch display screen. The inventive concept makes use of positional information for a first and a second spatially separated object detected at a first and a second coordinate, respectively, at a surface of the touch interface, for determining if a relation exists there between. Typically, the first and the second objects are at least one of a body part, such as a finger, or a conductive stylus and thus different types of relations may be determined.

In an embodiment where the first and the second objects are body parts, it may in accordance to the invention be possible to determine if the first and the second object are related as to that they are e.g. fingers of the same hand of a first user, fingers of different hands of the first user, or a finger of the hand of the first user and a finger of a hand of a second user.

Determination if a relation exists between the first and the second object may for example comprise determining if there exists an electrical coupling between the first and the second object. In such an embodiment the touch interface typically comprises a plurality of spatially separated touch areas connected to the touch control circuitry. The touch areas may in a possible embodiment be individually addressable elements of the touch interface, where each “touch pixel point” of the touch interface is provided with a touch area. In another embodiment the set of touch areas comprises a first and a second set of conductive lines comprised with the touch user interface, where for example the first set of conductive lines is orthogonal to the second set of conductive lines. Other configurations are possible and within the scope of the invention. The inventive concept may also be implemented in relation to the use of in-cell touch sensor technology.

For determining if there exist an electrical coupling between the first and the second object, it may for example in one embodiment of the invention be possible to transmit a predetermined signal from a touch area at the first coordinate and to analyze a representation of the predetermined signal at a touch area at the second coordinate. As such, in case of a touch interface having a pixel based approach, this embodiment may be realized by transmitting the predetermined signal from a single pixel based touch area corresponding to the first coordinate, and detect if a representation of the predetermined signal may be acquired from a single pixel based touch area corresponding to the second coordinate.

As understood based on the above, in case there is an electrical coupling between the first and the second object and the first and the second object are body parts, such as a first and a second finger of the first user, the signal transmitted from the touch area corresponding to the first coordinate will be received by the first finger of the first user, “travel through” the body of the first user and be emitted from the second finger of the first user into the touch area corresponding to the second coordinate. In case the first object is a finger of the first user and the second object is a finger of the second user, there will be no electrical coupling between the first and the second object—as long as the first and the second users are not in electrical contact with each other (such as e.g. holding each others uncovered hands). The same situation will of course occur in case the first object is a first finger of the first user, and the second object is stylus operated by the first user, where a handle of the stylus is insulated and thus providing an electrical connection between the first user and the second coordinate.

By means of the possibility of detecting if there exist a relation, such as for example the above discussed electrical connection, between the first and the second object, it may be possible to provide improved usability of the electronic device, for example allowing improved collaboration around a single touch screen. This since a first and a second user operating the single touch screen may be separated from each other, for example allowing a single GUI to be operated by both the first and the second users, where the input by each of the users may be handled separately. Examples of applications being possible by means of the inventive concept will be further discussed below in relation to the detailed description of the invention.

In the discussion above, the electrical coupling between the first and the second user has been determined by transmitting and receiving signals at single pixel touch areas. However, the concept of establishing an electrical coupling between the first and the second object may of course also be possible when the touch areas of the touch interface is implemented using the first and the second set of conductive lines. In a possible embodiment the predetermined signal is transmitted from a first line having correspondence to the first coordinate and received at a second line having correspondence to the second coordinate. In such a case, the first and the second lines are advantageously selected based on information relating to the first and the second coordinate and such that they are non-related.

In a preferred embodiment of the invention the touch control circuitry is configured to determine the electrical coupling between the first and the second object by—transmitting a predetermined signal from a first conductive line of the first set of conductive lines, and transmitting the predetermined signal from a first conductive line of the second set of conductive lines, wherein the first conductive line of the first set of conductive lines and the first conductive line of the second set of conductive lines are selected to correspond to the first coordinate for the first object. In addition, the control circuitry is configured to receive a representation of the predetermined signal at a second conductive line of the first set of conductive lines, and to receive a representation of the predetermined signal at a second conductive line of the second set of conductive lines, wherein the second conductive line of the first set of conductive lines and the second conductive line of the second set of conductive lines are selected to correspond to the second coordinate for the second object.

Accordingly, in an embodiment where the first and the second lines are orthogonally arranged in relation to each other and defined as x-lines and y-lines, the predetermined signal is transmitted at both the x- and y-lines of the first coordinate and received at both the x- and y-lines of the second coordinate. One advantage with such an implementation is that it effectively increases the strength of the signal transmitted at the first coordinate, and thus the signal received at the second coordinate will also preferably have an increased strength as compared the previously discussed implementations. In addition, by transmitting at two lines and receiving at two lines, it is possible to eliminate false relations as may be possible when only transmitting/receiving at a single conductive line.

Preferably, the predetermined signal is selected to reduce interference from a surrounding of the touch system and/or selected based on a conductivity model for the human body. For example, the signal may be selected to have an essentially sinusoidal waveform, having a frequency below 100 kHz. However, it should be understood that the predetermined signal may have a different waveform, having a frequency that is both higher and lower than 100 kHz.

It may in accordance to the invention also be possible to, alternatively, determine the electrical coupling between the first and the second object by matching an “electrical profile” for a user with a predetermined reference profile for each user. In such an embodiment the user may have to, in advance, be “trained” for the touch system before any comparison may be possible. For example a database may be formed a plurality of profiles or knowledge of difference between hands, fingers, etc. The profile information may alternatively be combined with the analysis of the representative signal received at the second coordinate, for example for identifying if received signal relates to the same hand, different hands, etc.

According to another aspect of the invention there is provided a method for operating a multiple-user touch system for an electronic device, the touch system comprising a touch user interface, and touch control circuitry connected to the touch user interface, wherein the method comprises the step of determining if a first object being positioned at a first coordinate at the touch user interface is related to a second object being positioned at a second coordinate at the touch user interface, wherein the first and the second coordinate are spatially separated at the touch user interface and the step of determining the relation between the first and the second object is based on information relating to the first and the second coordinate for the first and the second object, respectively. This aspect of the invention provides similar advantages as discussed above in relation to the previous aspects of the invention.

According to a still further aspect of the invention there is provided a program product comprising a computer readable medium having stored thereon computer program means for operating a multiple-user touch system for an electronic device, the touch system comprising a touch user interface, and touch control circuitry connected to the touch user interface, the computer program product comprising code for determining if a first object being positioned at a first coordinate at the touch user interface is related to a second object being positioned at a second coordinate at the touch user interface, wherein the first and the second coordinate are spatially separated at the touch user interface and the step of determining the relation between the first and the second object is based on information relating to the first and the second coordinate for the first and the second object, respectively.

Further features of, and advantages with, the present invention will become apparent when studying the appended claims and the following description. The skilled addressee realize that different features of the present invention may be combined to create embodiments other than those described in the following, without departing from the scope of the present invention.

### BRIEF DESCRIPTION OF THE DRAWINGS

The various aspects of the invention, including its particular features and advantages, will be readily understood from the following detailed description and the accompanying drawing, in which:

FIG. 1 illustrates a touch system in accordance with a currently preferred embodiment of the invention;

FIG. 2 shows a possible hardware implementation provided in relation to the invention, and

FIG. 3 shows another possible hardware implementation provided in relation to the invention.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled addressee. Like reference characters refer to like elements throughout.

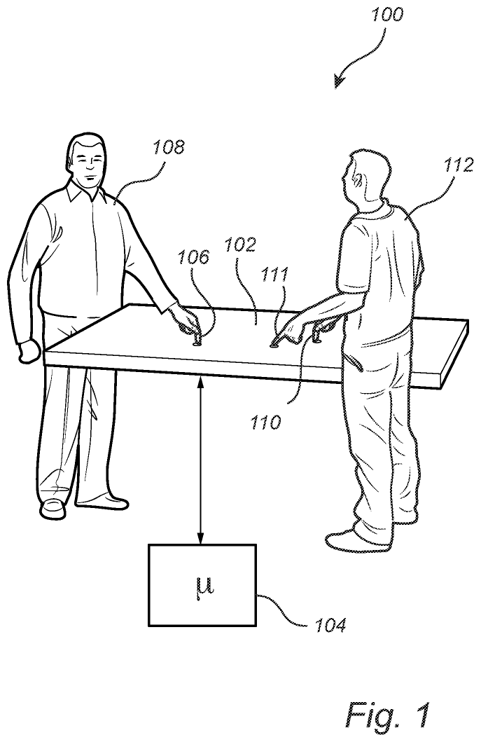

Referring now to FIG. 1, there is illustrated a touch system 100 in accordance with a currently preferred embodiment of the invention. The touch system 100 comprises a touch interface 102, typically integrated with a display screen. The touch system 100 further comprises a touch control circuitry 104, being any type of electronic computational device, such as including a microprocessor, microcontroller, programmable digital signal processor or another programmable device. The touch control circuitry 104 may also, or instead, include an application specific integrated circuit, a programmable gate array or programmable array logic, a programmable logic device, or a digital signal processor. Where the touch control circuitry 104 includes a programmable device such as the microprocessor, microcontroller or programmable digital signal processor mentioned above, the processor may further include computer executable code that controls operation of the programmable device.

The touch system 100 is, by means of the touch interface 102 and the touch control circuitry 104, configured to determine a relation between a first and a second object spatially separated at the touch user interface. The first object may for example be a first finger 106 of a first user 108, and the second object may be a first finger 110 of a second user 112, where the fingers 106, 110 of the first and the second user 108, 112 are in connection with or approaching the touch interface 102. Once in the vicinity of and/or touching the surface area of the touch interface 102, the touch control circuitry 104 is configured to determining the coordinates for the respective fingers 106, 110 of the first and the second user 108, 112.

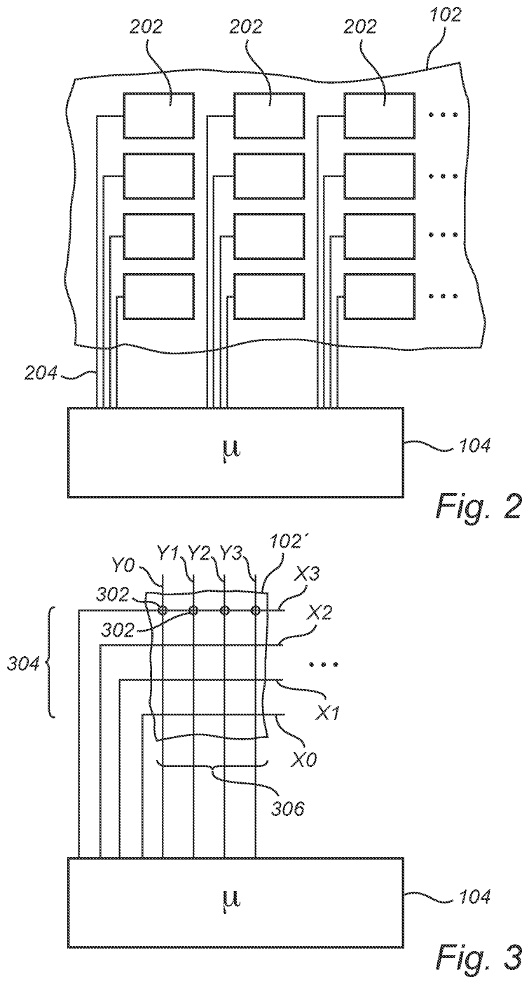

The touch interface 102 used in conjunction with the inventive concept may be configured in different ways, i.e. the inventive concept is applicable to different types of touch interface technologies. In FIG. 2 there is illustrated one type of touch interface technology, where the touch interface 102 is configured to comprise a plurality of individual touch areas 202. The touch areas 202 are in the illustrated embodiment individually accessible using control lines 204, where at least one control line 204 will provide a connection between the individual touch area 202 and the touch control circuitry. The control lines 204 are configured to allow for bi-directional signal transmission, i.e. a signal can be transmitted to an individual touch area 202 and a signal may also be received at an individual touch area 202.

During operation of the touch system 100 comprising a touch interface 102 as shown in FIG. 2, the touch interface 102 in combination with the touch control circuitry 104 is used for determining if any of the touch areas 202 are in contact with (or in a vicinity of) a detectable object, such as a finger, a stylus, etc. In the following example it is assumed that the first finger 106 of the first user 108 and the first finger 110 of the second user 112 are in contact with the surface of the touch interface 102. The touch control circuitry 104 transmits and receives signals according to a predetermine scheme for determining the coordinates of the fingers 106, 108.

In accordance to the invention, there is a desire to determine if there exists a relation between the fingers 106, 110. Typically, such a relation is defined as if there exists an electrical coupling between the fingers 106, 110. In an embodiment of the invention the electrical coupling is determined by transmitting a (suitable) predetermined signal, e.g. a signal having an essentially sinusoidal shaped waveform and having a frequency below e.g. 100 kHz, from a touch area 202 at the coordinate where the finger 106 has been detected. The coordinate where the finger 110 is detected is activated to determine if a representation of the predetermined signal may be acquired. In case the touch control circuitry, in analyzing what is received at the coordinate where the finger 110 is detected determines that the received signal in fact is a representation (e.g. by means of signal comparison, feature matching, or similar), there is estimated that a “bodily relation” exists. The bodily relation may in one embodiment be fingers from the same user, e.g. from the same or from different hands of the user.

However, in case no connection is found, a “non-bodily relation” is determined, i.e. that the coordinates where the fingers 106, 110 where detected are likely to relate to different persons. The display screen provided in relation to the touch interface 102 may be operated accordingly, i.e. providing different control possibilities/functionalities based on if objects of a single or two users are detected at the touch interface 102.

As understood based on the above, in case there is an electrical coupling between the first and the second object and the first and the second object are body parts, such as a first and a second finger of the first user, the signal transmitted from the touch area corresponding to the first coordinate will be received by the first finger of the first user, “travel through” the body of the first user and be emitted from the second finger of the first user into the touch area corresponding to the second coordinate. In case the first object is a finger of the first user and the second object is a finger of the second user, there will be no electrical coupling between the first and the second object—as long as the first and the second users are not in electrical contact with each other (such as e.g. holding each others uncovered hands). The same situation will of course occur in case the first object is a first finger of the first user, and the second object is stylus operated by the first user, where a handle of the stylus is insulated and thus providing an electrical connection between the first user and the second coordinate.

The example above is given in relation to two users 108, 112 operating the touch interface 102 of the touch system 100. The functionality provided in relation to the invention may of course scale to the case where more than two users operate the touch system 100, and where more than a single finger of each user is in contact (detectable) with the touch interface 102. In such a scenario there will exist more combinatorial possibilities that must be handled by the touch control circuitry 104.

In an alternative embodiment as compared to the touch interface shown in FIG. 2, the touch interface 102′ is configured to comprise a plurality of “touch intersection points” 302, addressable using a first 304 and a second 306 set of conductive lines connected to the touch control circuitry 104. In the general determination of the coordinates to the fingers 106, 110, the first set of conductive lines 304 may sequentially be made active (transmission of a predetermined signal), and the second set of conductive lines 306 are scanned for determining the presence of e.g. a detectable object which for example in relation to a capacitive implementation of the touch interface 102′ will generate a difference in response as compared to when no detectable object is present at the touch intersection point 302 (not being at the same coordinate as the coordinate of the first object, the term intersection point is used collectively for all intersections points 302 of the touch interface 102′). Within the concept of the invention, a conductive line (i.e. one of the lines of the first 304 or the second 306 lines of conductive lines) is to be seen as a touch area.

In a similar manner as discussed above, the first 304 and the second 306 set of conductive lines are in combination with the touch control circuitry 104 configured for bi-directional signal transmission. That is, in accordance to the invention, a signal may both be transmitted from and received at each of the first 304 and the second 306 set of conductive lines. This is in comparison to prior art where normally one of the sets are configured as “drive lines” and the other set is arranged as “sense lines”.

During operation of the touch system 100 comprising a touch interface 102′ as shown in FIG. 3, a similar approach as discussed in relation to FIG. 2 is taken for determining a relation between a first and a second object detected at a first and a second coordinate at the touch interface 102′. That is, the first 304 and the second 306 set of conductive lines are used in conjunction with the touch control circuitry 104 for determining if there is an electrical coupling between the first and the second object.

In an example, a first object is detected at a coordinate having a touch intersection point 302 corresponding to lines X3-Y0 of the first 304 and the second 306 set of conductive lines as indicated in FIG. 3. A second object is detected at a coordinate having a touch intersection point 302 corresponding to lines X3-Y1 of the first 304 and the second 306 set of conductive lines. In the example it is assumed that the first object is the finger 106 of the first user 108, i.e., finger 106 is detected at X3-Y0, and that the second object is the finger 110 of the second user 112, i.e. finger 110 is detected at X3-Y1.

In an exemplary embodiment, the touch control circuitry 104 is configured to simultaneously transmitting the predetermined signal from the conductive lines X3 and Y0 corresponding to the first coordinate. The touch control circuitry 104 is also configured to determine if a representation of the predetermined signal may be simultaneously acquired from the conductive lines X3 and Y1 corresponding to the second coordinate. The simultaneous transmission from and reception at “both” conductive lines has shown to be beneficial for making it possible to have a “large enough” signal to enter the first object (and if having an electrical connection), travel through a body or body part, and then again enter into the “receiving lines”. However, simultaneous transmission/reception by/from the conductive lines is not necessary, but should be seen as a preferred embodiment of the invention.

In an advantageous embodiment, the remaining lines, i.e., in the example above being X0, X1, X2, Y2 and Y3 are connected to ground to reduce any interference from neighboring “non used” lines. The signals received at the lines X3 and Y1 are amplified and sampled using an ADC. The signals may then typically be filtered using a digital FIR band pass filter. Alternatively, the signals may be processed by FFT for determining a frequency of the received signals. In addition, an amplitude of the signals may be determined (using an analogue band pass filter, e.g. a Chebyshev filter).

The digital representations (frequency, amplitude, etc.) of the received signals are then compared with reference value for this pair of coordinates. Reference value is measured without touch, and if the difference is larger than a predetermined threshold for this pair of coordinates, there is a connection. In the exemplary case where the first and the second objects are fingers from different users, the difference will be less than the predetermined threshold.

Again and as discussed above, a user interface provided at a display screen arranged adjacently to the touch interface 102′ may be adapted based the relation between the first and the second object. In addition, the example given above is provided for two fingers. However, the inventive concept scales for more fingers and more users. It should furthermore be noted the hardware implementation may be digital or analog, or a combination thereof. Furthermore, additional (further) touch areas (conductive lines) may be comprised with the touch interface 102/102′ that what are exemplified within the Figs.

Following the example above and with reference to FIGS. 1 and 3 in combination, the second user 112 is also in contact with the touch interface 102 with a second FIG. 111. The second finger 111 of the second user 112 provided at the touch intersection point 302 corresponding to lines X1-Y3.

Thus, the first object is detectable at X0-Y0 (finger 106 of the first user 108, the second object is detectable at X2-Y1 (finger 110 of the second user 112) and a third object is detectable at X1-Y3 (finger 111 of the second user 112). Following the above discussion of transmission and reception of signals at the first 304 and the second 306 sets of conductive lines, As discussed above, no electrical connection is found between the first and the second objects. Neither will an electrical connection be found between the first and the third object. Accordingly, a non-bodily relation is determined between the first and the second object as well as between the first and the third object.

However, a bodily relation is determined to exist between the second and the third object. By means of such a determination, the second and the third object (corresponding to the fingers 110 and 111 of the second user) are estimated to relate to the same user, in the present embodiment the second user 110. In summary, the present invention relates to a multiple-user touch system for an electronic device, the touch system comprising a touch user interface, and touch control circuitry connected to the touch user interface, the control circuitry being configured to determine if a first object being positioned at a first coordinate at the touch user interface is related to a second object being positioned at a second coordinate at the touch user interface, wherein the first and the second coordinate are spatially separated at the touch user interface and the relation between the first and the second object is determined based on information relating to the first and the second coordinate for the first and the second object, respectively.

Advantages with the invention include the possibility of providing improved usability of the electronic device, for example allowing improved collaboration around a single touch screen. This since a first and a second user operating the single touch screen may be separated from each other, for example allowing a single GUI to be operated by both the first and the second users, where the input by each of the users may be handled separately.

In addition, the control functionality of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a sequence the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps. Additionally, even though the invention has been described with reference to specific exemplifying embodiments thereof, many different alterations, modifications and the like will become apparent for those skilled in the art. Further, a single unit may perform the functions of several means recited in the claims. In the claims, any reference signs placed between parentheses shall not be construed as limiting to the claim. Furthermore, in the claims, the word “comprising” does not exclude other elements or steps, and the indefinite article “a” or “an” does not exclude a plurality.

Variations to the disclosed embodiments can be understood and effected by the skilled addressee in practicing the claimed invention, from a study of the drawings, the disclosure, and the appended claims. The person skilled in the art realizes that the present invention is not limited to the preferred embodiments.

1. A multiple-user touch system for an electronic device, the touch system comprising:
a touch user interface comprising a set of touch areas, and
touch control circuitry connected to the touch user interface, the touch control circuitry being configured to determine if a first object being positioned at a first coordinate at the touch user interface is electrically coupled to a second object being positioned at a second coordinate at the touch user interface by matching an electrical coupling between the first object and the second object with a plurality of different reference profiles being individual for a plurality of users,
wherein:
the electrical coupling between the first and the second object is determined by transmitting a predetermined electrical signal selected based on a conductivity model for a human body from a first touch area of the set of touch areas at the first coordinate and analyzing a representation of the predetermined electrical signal at a second touch area of the set of touch areas at the second coordinate,
the first and the second coordinate are spatially separated at the touch user interface and the electrical coupling between the first and the second object is determined based on information relating to the first and the second coordinate for the first and the second object, respectively,
each touch area of the set of touch areas comprises an intersection of at least one conductive line of a first set of conductive lines with at least one conductive line of a second set of conductive lines,
the predetermined electrical signal is transmitted from at least one transmitting conductive line of the first and second sets of conductive lines corresponding to the first touch area, wherein neighboring lines to the at least one transmitting conductive line of the first and second sets of conductive lines are connected to ground while the predetermined electrical signal is transmitted, and
analyzing the representation of the predetermined electrical signal at the second touch area comprises acquiring the representation of the predetermined electrical signal from at least one receiving conductive line of the first and second sets of conductive lines corresponding to the second touch area, wherein neighboring lines to the at least one receiving conductive line of the first and second sets of conductive lines corresponding to the second touch area are connected to ground while the predetermined electrical signal is transmitted.

2. The touch system according to claim 1, wherein the touch control circuitry is further configured to determine the first and the second coordinate of the first and the second object, respectively, at the touch user interface.

3. The touch system according to claim 1, wherein the first set of conductive lines is orthogonal to the second set of conductive lines.

4. The touch system according to claim 1, wherein the first and the second coordinate is determined by activating the first set of conductive lines and scanning the second set of conductive lines.

5. The touch system according to claim 1, wherein the first and the second objects are at least one of a body part or a conductive stylus.

6. The touch system according to claim 1, wherein the touch user interface is a touch screen.

7. The touch system according to claim 1, further comprising a display element arranged adjacently to the touch sensor.

8. The touch system according to claim 1, wherein the predetermined signal is further selected to reduce interference from a surrounding of the touch system.

9. The touch system according to claim 1, wherein a specific reference profile, corresponding to a specific user, of the plurality of different reference profiles is different for different hands and fingers of the specific user.

10. The touch system according to claim 1, wherein a specific reference profile, corresponding to a specific user, of the plurality of different reference profiles is trained in advance.

11. The touch system according to claim 1, wherein the predetermined electrical signal is transmitted from at least one transmitting conductive line of the first set of conductive lines and at least one transmitting conductive line of the second set of conductive lines corresponding to the first touch area, and wherein analyzing the representation of the predetermined electrical signal at the second touch area comprises acquiring the representation of the predetermined electrical signal from at least one receiving conductive line of the first set of conductive lines and at least one receiving conductive line of the second set of conductive lines corresponding to the second touch area.

12. A method for operating a multiple-user touch system for an electronic device, the touch system comprising a touch user interface comprising a set of touch areas, and touch control circuitry connected to the touch user interface, wherein the method comprises the step of:
determining if a first object being positioned at a first coordinate at the touch user interface is electrically coupled to a second object being positioned at a second coordinate at the touch user interface by matching an electrical coupling between the first object and the second object with a plurality of different reference profiles being individual for a plurality of users,
wherein:
the electrical coupling between the first and the second object is determined by transmitting a predetermined electrical signal selected based on a conductivity model for a human body from a first touch area of the set of touch areas at the first coordinate and analyzing a representation of the predetermined electrical signal at a second touch area of the set of touch areas at the second coordinate,
the first and the second coordinate are spatially separated at the touch user interface and the step of determining the electrical coupling between the first and the second object is based on information relating to the first and the second coordinate for the first and the second object, respectively,
each touch area of the set of touch areas comprises an intersection of at least one conductive line of a first set of conductive lines with at least one conductive line of a second set of conductive lines,
the predetermined electrical signal is transmitted from at least one transmitting conductive line of the first and second sets of conductive lines corresponding to the first touch area, wherein neighboring lines to the at least one transmitting conductive line of the first and second sets of conductive lines are connected to ground while the predetermined electrical signal is transmitted, and
analyzing the representation of the predetermined electrical signal at the second touch area comprises acquiring the representation of the predetermined electrical signal from at least one receiving conductive line of the first and second sets of conductive lines corresponding to the second touch area, wherein neighboring lines to the at least one receiving conductive line of the first and second sets of conductive lines corresponding to the second touch area are connected to ground while the predetermined electrical signal is transmitted.

13. The method according to claim 12, wherein a specific reference profile, corresponding to a specific user, of the plurality of different reference profiles is different for different hands and fingers of the specific user.

14. The method according to claim 12, wherein a specific reference profile, corresponding to a specific user, of the plurality of different reference profiles is trained in advance.

15. The method according to claim 12, wherein the predetermined electrical signal is transmitted from at least one transmitting conductive line of the first set of conductive lines and at least one transmitting conductive line of the second set of conductive lines corresponding to the first touch area, and wherein analyzing the representation of the predetermined electrical signal at the second touch area comprises acquiring the representation of the predetermined electrical signal from at least one receiving conductive line of the first set of conductive lines and at least one receiving conductive line of the second set of conductive lines corresponding to the second touch area.

16. A computer program product comprising a non-transitory computer readable medium having stored thereon computer program means for operating a multiple-user touch system for an electronic device, the touch system comprising a touch user interface comprising a set of touch areas, and touch control circuitry connected to the touch user interface, the computer program product comprising:
code for determining if a first object being positioned at a first coordinate at the touch user interface is electrically coupled to a second object being positioned at a second coordinate at the touch user interface by matching an electrical coupling between the first object and the second object with a plurality of different reference profiles being individual for a plurality of users,
wherein:
the electrical coupling between the first and the second object is determined by transmitting a predetermined electrical signal selected based on a conductivity model for a human body from a first touch area of the set of touch areas at the first coordinate and analyzing a representation of the predetermined electrical signal at a second touch area of the set of touch areas at the second coordinate,
the first and the second coordinate are spatially separated at the touch user interface and the step of determining the electrical coupling between the first and the second object is based on information relating to the first and the second coordinate for the first and the second object, respectively,
each touch area of the set of touch areas comprises an intersection of at least one conductive line of a first set of conductive lines with at least one conductive line of a second set of conductive lines,
the predetermined electrical signal is transmitted from at least one transmitting conductive line of the first and second sets of conductive lines corresponding to the first touch area, wherein neighboring lines to the at least one transmitting conductive line of the first and second sets of conductive lines are connected to ground while the predetermined electrical signal is transmitted, and
analyzing the representation of the predetermined electrical signal at the second touch area comprises acquiring the representation of the predetermined electrical signal from at least one receiving conductive line of the first and second sets of conductive lines corresponding to the second touch area, wherein neighboring lines to the at least one receiving conductive line of the first and second sets of conductive lines corresponding to the second touch area are connected to ground while the predetermined electrical signal is transmitted.

17. The computer program product of claim 16, wherein a specific reference profile, corresponding to a specific user, of the plurality of different reference profiles is different for different hands and fingers of the specific user.

18. The computer program product of claim 16, wherein a specific reference profile, corresponding to a specific user, of the plurality of different reference profiles is trained in advance.

19. The computer program product of claim 16, wherein the predetermined electrical signal is transmitted from at least one transmitting conductive line of the first set of conductive lines and at least one transmitting conductive line of the second set of conductive lines corresponding to the first touch area, and wherein analyzing the representation of the predetermined electrical signal at the second touch area comprises acquiring the representation of the predetermined electrical signal from at least one receiving conductive line of the first set of conductive lines and at least one receiving conductive line of the second set of conductive lines corresponding to the second touch area.
